(19) United States
(12) Patent Application Publication
(10) Pub. No.: US 2005/0200133 A1
(43) Pub. Date: Sep. 15, 2005

(54) Separate network and method for operating a separate network

(76) Inventor: Aloys Wobben, Aurich (DE)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/506,944

(22) PCT Filed: Feb. 27, 2003
(86) PCT No.: PCT/EP03/01981

§ 371 Date: Apr. 28, 2005

(30) Foreign Application Priority Data
Mar. 8, 2002 (DE) 102 10 099.3

(51) Int. Cl. H02K 1/00; F03D 9/00

(52) U.S. Cl. 290/55; 310/10

(57) ABSTRACT

The present invention relates to an isolated network with at least one power generator, which uses renewable energy sources, wherein the power generator is preferably a wind-power station with a first synchronous generator, with a dc voltage intermediate circuit with at least a first rectifier and an inverter, with a second synchronous generator and an internal combustion engine that can be coupled to the second synchronous generator. To realize an isolated network, for which the internal combustion engine can be deactivated completely, as long as the wind-power station generates sufficient power for all connected loads at the highest possible efficiency, a completely controllable wind-power station and an electromagnetic coupling between the second synchronous generator and the internal combustion engine are provided.

### BACKGROUND OF THE INVENTION

1. Field of the Invention

The present invention relates to an electrical island network with at least one power source, which is coupled to a first electric generator. A second generator is further provided, which can be coupled to an internal combustion engine. In such island networks, the power source, which is connected to the first electric generator, preferably a renewable-energy power generator, such as a wind-power station, hydroelectric power plant, etc.

2. Description of the Related Art

Island networks are generally known and are used especially for supplying power to areas, which are not connected to a central power-supply network but in which renewable energy sources, such as wind and/or sun and/or water power, and the like, are available. These areas referred to herein as an island can be an island in the ocean, or other isolated locations for example, a remote or hard-to-reach areas with isolation in terms of size, location, and/or weather patterns. This may include off-shore arctic areas, isolated mountain regions, deserts, or other locations that are isolated from public power supplies. However, power, water, and heat also must be supplied to such areas. The energy required for these systems, at least the electrical energy, is provided and distributed by island network. However, for fault-free operation, modern electrical devices require the maintenance of relatively strict limit values for voltage and/or frequency fluctuations in the island network.

To be able to maintain these limiting values, among other things, so-called wind-diesel systems are used, for which a wind-power station is used as the primary energy source. The alternating current generated by the wind-power station is rectified and then converted by an inverter into alternating current with the required network power frequency. This method generates a network power frequency that is independent of the rpm of the wind-power station generator, and thus of its frequency.

Therefore, the network power frequency is determined by the inverter. Here, two different variants are available. The first variant is a so-called self-commutated inverter, which can generate a stable network power frequency itself. However, such self-commutated inverters require high technical expense and are correspondingly expensive. One alternative variant to a self-commutated inverter is a network-commutated inverter, which synchronizes the frequency of its output voltage with an existing network. Such inverters are considerably more economical than self-commutated inverters, but always require a network, with which they can be synchronized. Therefore, for a network-commutated inverter, a network generator must always be available, which provides the control parameters necessary for network control of the inverter. Such a network generator is a synchronous generator, for example, which is driven by an internal combustion engine (diesel motor), in known island networks.

This means that the internal combustion engine must run continuously to drive the synchronous generator as the network generator. This is also disadvantageous in view of maintenance requirements, fuel consumption, and the loading of the environment with exhaust gases, because even if the internal combustion engine must provide only a fraction of its available power for driving the generator as the network generator, the power frequently equals only 3-5 kW, and the fuel consumption is not insignificant but equals several liters of fuel per hour.

Another problem for known island networks is that so-called “dump loads” must be provided, which consume the excess electrical energy generated by the primary power generator, so that the primary power generator is not set into a free-running operation when loads are turned off, which in turn could lead to mechanical damage to the primary power generator due to an rpm that is too high. This is especially problematic for wind-power stations as the primary power generators.

### BRIEF SUMMARY OF THE INVENTION

The invention is based on preventing the previously mentioned disadvantages and improving the efficiency of an island network.

According to the invention with an electrical island network with the features according to Claims 1 and 16, as well as with a method for operation control of an island network according to Claim 19 are provided. Advantageous refinements are described in the subordinate claims.

The invention is based on the knowledge that the second generator, which has the function of the network generator, can also be driven with the electrical energy of the primary power generator (wind-power station), so that the internal combustion engine can be completely turned off and decoupled from the second generator. Here, the second generator is no longer in generator operation, but instead in motor operation, wherein the electrical energy required for this function is delivered by the primary power generator or its generator. If the coupling between the second generator and the internal combustion engine is an electromagnetic coupling, then this coupling can be activated by supplying electrical power from the primary power generator or its generator. If the electrical power is turned off at the coupling, the coupling is separated. The second generator is then powered and driven (motor operation) with electrical energy from the primary power generator as previously described, for the deactivated operation of the internal combustion engine, so that despite the deactivated internal combustion engine, the network generator remains in operation. As soon as activation of the internal combustion engine and thus the generator operation of the second generator is required, the internal combustion engine can be started and coupled by means of the electrically activated coupling with the second generator so that this second generator can provide additional energy for the electrical island network in the generator operation.

The use of a completely controllable wind-power station permits the elimination of “dump loads,” because the wind-power station is able to generate the required power through its complete controllability, thus variable rpm and variable blade position, so that “disposal” of excess energy is not required since the wind-power station generates the exact amount of required power. Therefore, so that the wind-power station generates only as much energy as needed in the network (or is required for recharging intermediate storage devices), no excess power must be consumed uselessly and the total efficiency of the wind-power station but also of the entire island network becomes considerably better than for the use of “dump loads.”

In one preferred embodiment of the invention, the wind-power station contains a synchronous generator, which is connected after an inverter. This inverter consists of a rectifier, a dc voltage intermediate circuit, and a frequency converter. If another energy source providing another dc voltage (dc current), e.g., a photovoltaic element, is embodied in the island network, then it is advantageous that such other primary power generators, such as photovoltaic elements, are connected to the dc voltage intermediate circuit of the inverter, so that the energy of the additional renewable energy source can be fed into the dc voltage intermediate circuit. This configuration can increase the power made available by the first primary power generator.

On one hand, to equalize fluctuations of the available power and/or an increased power demand spontaneously and, on the other hand, to be able to use available energy, which is not in demand at the moment, preferably intermediate storage devices are provided, which store electrical energy and which can be discharged quickly on demand. Such storage devices can be, e.g., electrochemical storage devices like accumulators, but also capacitors (caps) or also chemical storage devices like hydrogen storage devices, which store hydrogen generated by electrolysis with the excess electrical energy. To discharge their electrical energy, such storage devices are also connected directly or via corresponding charging/discharging circuits to the dc voltage intermediate circuit of the inverter.

Another form of energy storage is the conversion into rotational energy, which is stored in a flywheel. This flywheel is coupled to the second synchronous generator in a preferred refinement of the invention and thus also permits the stored energy to be used for driving the network generator.

All storage devices can be supplied with electrical energy when the energy consumption in the island network is less than the power capacity of the primary power generator, e.g., the wind-power station. For example, if the primary power generator is a wind-power station with 1.5 MW nominal power or a wind array with several wind-power stations with 10 MW nominal power and the wind patterns are such that the primary power generator can be operated in normal mode, although the power consumption in the island network is clearly less than the nominal power of the primary power generator, in such a mode (especially at night and in times of low consumption in the island network), the primary power generator is controlled such that all energy storage devices are charged (filled). In this way, the energy storage devices can be activated, under some circumstances only temporarily, in times when the power consumption of the island network is greater than the power made available by the primary power generator.

In one preferred refinement of the invention, all power generators and intermediate storage devices with the exception of the energy components connected to the second generator (internal combustion engine, flywheel) are connected to a common dc voltage intermediate circuit, which is configured like a bus and which is terminated with an individual, network-commutated converter (inverter). The use of an individual, network-commutated inverter on a dc voltage intermediate circuit produces a very economical arrangement.

It is further advantageous when other (redundant) internal combustion engines and third generators (e.g., synchronous generators) that can be coupled to these engines are provided to generate power by operating the other (redundant) generator systems when there is a greater power demand than is available from the renewable-energy power generators and the stored power.

In general, the power frequency in the network can be used to determine whether the available power corresponds to the required power. For an excess supply of power, the network power frequency increases, while it falls for too little power. However, such frequency deviations appear delayed and equalizing such frequency deviations becomes more and more difficult with increasing complexity of the network.

To enable fast adaptation to the power, a device, which can detect the power required in the network, is connected to the bus bar. In this way, a demand for power or an excess supply of power can be recognized and compensated immediately before fluctuations in the network power frequency can appear at all.

### BRIEF DESCRIPTION OF THE SEVERAL VIEWS OF THE DRAWINGS

In the following, an embodiment of the invention is explained in more detail as an example. Shown here are:

FIG. 1, a block circuit diagram of an island network according to the invention;

FIG. 2, a variant of the principle shown in FIG. 1; and

FIG. 3, a preferred embodiment of an island network according to the invention.

### DETAILED DESCRIPTION OF THE INVENTION

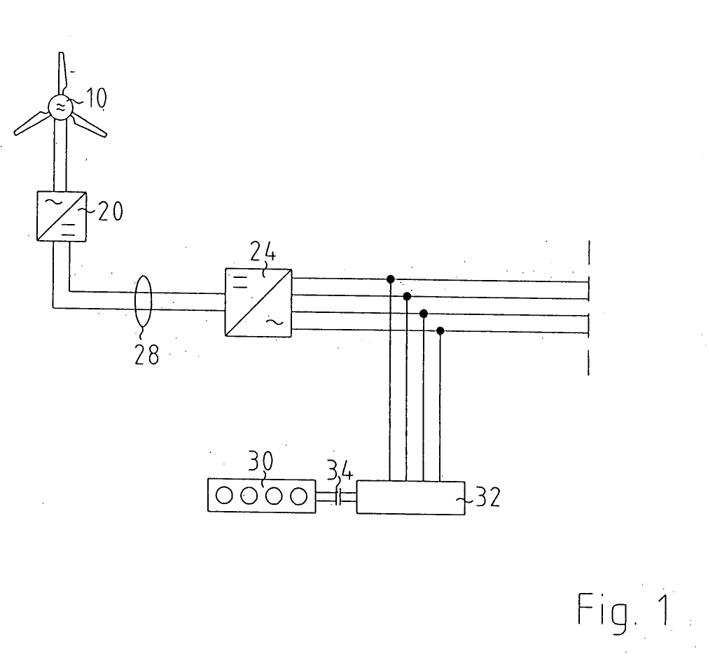

FIG. 1 shows a wind-power station with a downstream converter consisting of a rectifier 20, by means of which the wind-power station is connected to a dc voltage intermediate circuit 28, as well as an inverter 24 connected to the output of the dc voltage intermediate circuit 28.

In parallel to the output of the inverter 24, a second synchronous generator 32 is connected, which is connected in turn via an electromagnetic coupling 34 to an internal combustion engine 30. The output lines of the inverter 24 and the second synchronous generator 32 provide the (not shown) load with the required energy.

In this way, the wind-power station 10 generates the power to be supplied to the load. The energy generated by the wind-power station 10 is rectified by the rectifier 20 and fed into the dc voltage intermediate circuit 28.

The inverter 24 generates an alternating voltage from the applied dc voltage and feeds it into the island network. Because the inverter 24 is embodied for reasons of cost preferably as a network-commutated inverter, a network generator is present, with which the inverter 24 can be synchronized.

This network generator is the second synchronous generator 32. This synchronous generator 32 works for a deactivated internal combustion engine 30 in the motor operation and here acts as a network generator. In this operation mode, the drive energy is electrical energy from the wind-power station 10. This drive energy for the synchronous generator 32 must also be generated by the wind-power station 10 just like the losses of the rectifier 20 and the inverter 24.

In addition to the function of the network generator, the second synchronous generator 32 performs other tasks, like the reactive power generation in the network, the supply of short-circuit current, acting as a flicker filter, and voltage regulation.

If loads are turned off and thus the energy demand falls, then the wind-power station 10 is controlled so that it generates less energy correspondingly, so that the use of dump loads can be eliminated.

If the energy demand of the loads increases so much that this can no longer be covered only by the wind-power station, the internal combustion engine 28 can be started and a voltage is applied to the electromagnetic coupling 34. In this way, the coupling 34 creates a mechanical connection between the internal combustion engine 30 and the second synchronous generator 32 and the generator 32 (and network generator) supplies the required energy (now in generator operation).

Through suitable dimensioning of the wind-power station 10, it can be achieved that on average sufficient energy for powering the loads is provided from wind power. Therefore, the use of the internal combustion engine 30 and the resulting fuel consumption is reduced to a minimum.

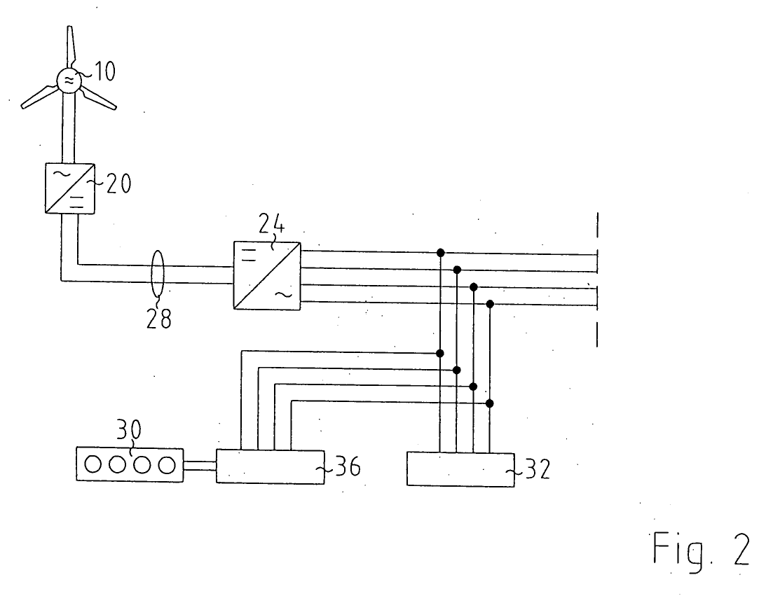

In FIG. 2, a variant of the island network shown in FIG. 1 is shown. The setup essentially corresponds to the solution shown in FIG. 1. The difference here is that no internal combustion engine 30 is assigned to the second generator 32, which acts as the network generator. The internal combustion engine 30 is connected to another third (synchronous) generator 36, which can be activated on demand. The second synchronous generator 32 thus operates constantly in motor operation as the network generator, reactive-power generator, short-circuit current source, flicker filter, and voltage regulator.

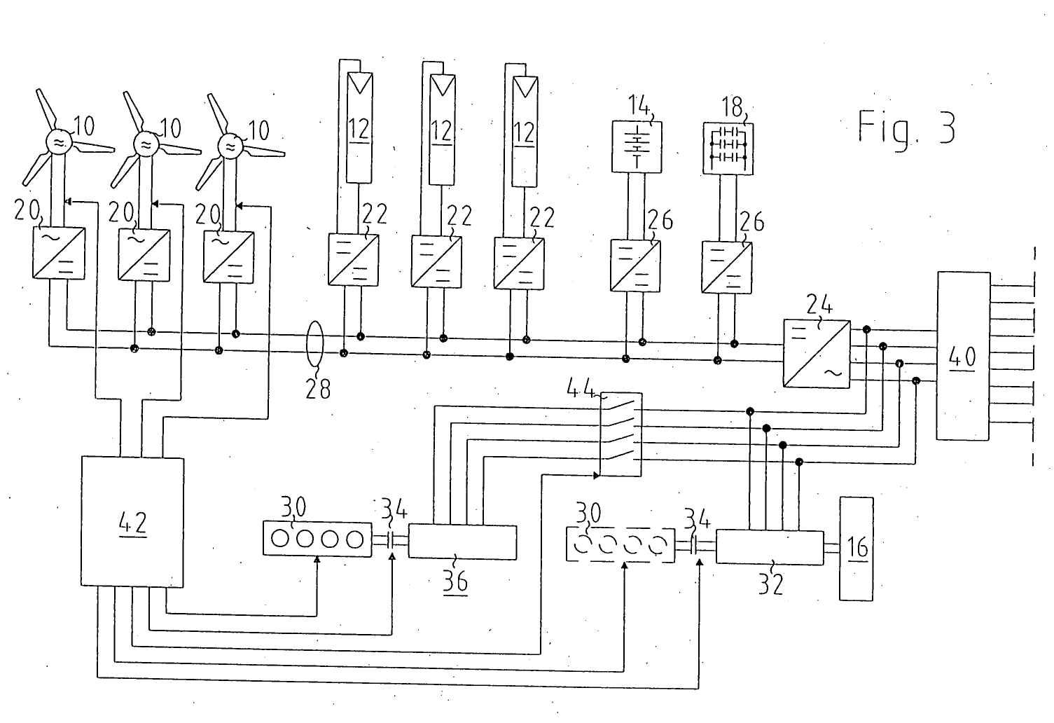

In FIG. 3, another preferred embodiment of an island network is shown. This figure shows three wind-power stations 10, which form, e.g., a wind array, with first (synchronous) generators, which are each connected to a rectifier 20. The rectifiers 20 are connected in parallel to the output side and feed the energy generated by the wind-power station 10 into a dc voltage intermediate circuit 28.

Furthermore, three photovoltaic elements 12 are shown, which are each connected to a boost converter 22. The output sides of the boost converters 22 are connected in parallel to the dc voltage intermediate circuit 28.

Furthermore, an accumulator block 14 is shown, which stands symbolically for an intermediate storage device. In addition to an electrochemical storage device like the accumulator 14, this intermediate storage device can be a chemical as well as a hydrogen storage device (not shown). The hydrogen storage device can be coated with hydrogen, for example, which is obtained by electrolysis.

Next to this, a capacitor block 18 is shown, which exhibits the ability of using suitable capacitors as intermediate storage devices. These capacitors can be so-called Ultra-caps from Siemens, for example, which are distinguished by low losses in addition to high storage capacity.

Accumulator block 14 and capacitor block 18 (both blocks can also have several instances) are each connected via charging/discharging circuits 26 to the dc voltage intermediate circuit 28. The dc voltage intermediate circuit 28 is terminated with a (single) inverter 24 (or a plurality of inverters connected in parallel), wherein the inverter 24 is preferably embodied in a network-commutated way.

On the output side of the inverter 24, a distributor 40 (optionally with a transformer) is connected, which is powered by the inverter 24 with the network voltage. On the output side of the inverter 24, a second synchronous generator 32 is also connected. This synchronous generator 32 is the network generator, reactive power and short-circuit current generator, flicker filter, and voltage regulator of the island network.

A flywheel 16 is coupled to the second synchronous generator 32. This flywheel 16 is also an intermediate storage device and can store energy, e.g., during the motor-driven operation of the network generator.

In addition, an internal combustion engine 30 and an electromagnetic coupling 34, which drive the generator 32 and which operate as a generator when there is too little power from renewable energy sources, can be assigned to the second synchronous generator 32. In this way, the missing energy can be fed into the island network.

The internal combustion engine 30 assigned to the second synchronous generator 32 and the electromagnetic coupling 34 are indicated by dashed lines to make clear that the second synchronous generator 32 can be operated alternatively only in motor mode (and optionally with a flywheel as an intermediate storage device) as the network generator, reactive-power generator, short-circuit current source, flicker filter, and voltage regulator.

Especially when the second synchronous generator 32 is provided without internal combustion engine 30, a third synchronous generator 36 with an internal combustion engine can be provided to equalize a longer lasting power gap. This third synchronous generator 36 can be separated from the island network by a switching device 44 in rest mode in order not to load the island network as an additional energy load.

Finally, a (μp/computer) controller 42 is provided, which controls the individual components of the island network and thus allows an essentially automatic operation of the island network.

Through suitable design of the individual components of the island network, the wind-power station 10 can provide on average sufficient energy for the loads. This supply of energy is optionally supplemented by the photovoltaic elements.

If the power supplied by the wind-power station 10 and/or the photovoltaic elements 12 is less/greater than the demand from the loads, the intermediate storage devices 14, 16, 18 can be applied (discharged/charged) to either supply (discharge) the missing power or to store (charge) the excess energy. The intermediate storage devices 14, 16, 18 thus smooth the constantly fluctuating supply from the renewable energies.

Here, it is essentially dependent on the storage capacity of the intermediate storage devices 14, 16, 18, over what time period what power fluctuation can be equalized. With over-dimensioning of the intermediate storage devices, a few hours up to a few days can be set as the time period.

The internal combustion engines 30 and the second or third synchronous generators 32, 36 must be turned on only if there are power gaps that exceed the capacity of the intermediate storage devices 14, 16, 18.

In the preceding description of the embodiments, the primary power generator is always one that uses a renewable energy source, such as wind or sun (light). However, the primary power generator can also operate with another renewable energy source, e.g., water power, or it can also be a generator, which consumes fossil fuels.

A seawater desalination plant (not shown) can also be connected to the island network, so that in times, in which the loads on the island network require significantly less electrical power than the primary power generator can provide, the seawater desalination plant consumes the “excess,” i.e., still available, electrical power to generate service water/drinking water, which can then be stored in reservoirs. If at certain times the electrical energy consumption of the island network is so large that all energy generators are barely able to provide this power, the seawater desalination plant operation is brought down to a minimum, optionally even completely deactivated. Also, the seawater desalination plant can be controlled by the controller 42.

During those times that the electrical power of the primary power generator is only partially required by the electrical network, a pump storage device, which is also not shown, can also be operated, by means of which water (or other liquid media) is brought from a low potential to a high potential, so that when needed, the electrical power of the pump storage device can be accessed. The pump storage device can also be controlled by the controller 42.

It is also possible that the seawater desalination plant and a pump storage device are combined, in that the service water (drinking water) generated by the seawater desalination plant is pumped to a higher level, which can then be used to drive the generators of the pump storage device if needed.

As an alternative to the variants of the invention described and shown in FIG. 3, other variations to the solution according to the invention can also be performed. For example, the electrical power of the generators 32 and 36 (see FIG. 3) can be fed rectified via a rectifier to the bus bar 28.

Then, if the power supplied by the primary power generator 10 or the intermediate storage devices 12, 14, 16, 18 is too low or is applied as much as possible, the internal combustion engine 30 is started and this then drives the generator 32, 36. The internal combustion engine then provides the electrical energy within the island network as much as possible for the island network, but simultaneously it can also charge the intermediate storage device 16, thus the flywheel in turn, and for feeding the electrical energy, the generators 32 and 36 in the dc current intermediate circuit 28 can also charge the intermediate storage devices 14, 18 shown there. Such a solution has the advantage, in particular, that the internal combustion engine can run in an advantageous, namely, optimal operation, where the exhaust gases are also kept as low as possible and also the rpm is in an optimum range, so that the consumption of the internal combustion engine is in the best possible range. For such an operation, when, e.g., the intermediate storage devices 14, 18, or 16 are filled as much as possible, the internal combustion engine can then be deactivated, and then the network power supply is realized as much as possible with the energy stored in the storage devices 14, 16, 18, if insufficient energy can be provided from the energy generators 10, 12. If the charge state of the intermediate storage devices 14, 16, 18 falls below a critical value, then in turn the internal combustion engine is turned on, and energy provided by the internal combustion engine 30 is supplied to the generators 32 and 36 in the dc current intermediate circuit 28 and the intermediate storage devices 14, 16, 18 are also charged in turn.

In the previously described variants, care is taken especially that the internal combustion engine can run in an optimum rpm range, which improves its overall operation.

Here, conventional rectifiers (e.g., rectifier 20) are connected downstream in the generators 32, 36, by means of which the electrical energy is fed into the dc current intermediate circuit 28.

A form of the applied intermediate storage device 14 is an accumulator block, e.g., a battery. Another form of the intermediate storage device is a capacitor block 18, e.g., an Ultracap model capacitor from Siemens. The charging behavior, but primarily the discharging behavior of the previously mentioned intermediate storage device is relatively different and should be addressed in the present invention.

Thus, accumulators, like other conventional batteries, exhibit a loss in capacity, even if small, but irreversible, for each charge/discharge cycle. For very frequent charge/discharge cycles, in a comparatively short time this leads to a significant loss in capacity, which makes a replacement of this intermediate storage device necessary in a correspondingly fast time depending on the application.

Dynamically loadable intermediate storage devices like an Ultracap model capacitor storage device or also a flywheel storage device do not have the previously mentioned problem. However, Ultracap model capacitor storage devices and also flywheel storage devices are considerably more expensive than a conventional accumulator block or other battery storage devices in terms of a single kilowatt-hour.

Unlike the application of renewable raw materials or solar energy, wind energy can rarely be reliably predicted. Thus, attempts are made to generate as much energy as possible with renewable sources and, if this energy cannot be consumed, to store it in storage devices with the largest possible storage capacities in order to have this energy available and to be able to discharge it when needed. Naturally, all energy storage devices are designed with maximum size to be able to bridge the longest possible times without power.

Another difference between intermediate storage devices of the accumulator block type and Ultracap model intermediate storage devices or flywheel storage devices is that the electrical power of Ultracaps and flywheel storage devices can be discharged within a very short time without harm, while intermediate storage devices of the accumulator block type do not have such a high discharge rate (DE/DT).

Therefore, one aspect of the invention of the present application is also that the different intermediate storage devices of different types can be used as a function of their operating properties and costs for various tasks. In light of the preceding observations, it thus also does not appear to be sensible to use an intermediate storage device of a flywheel storage device type or an Ultracap with maximum capacity in order to bridge the longest possible times without power, but these storage devices do have their strengths, especially in being able to bridge short times without power without harm to the intermediate storage devices, while they are very expensive for bridging very long times without power.

It is also not meaningful to use intermediate storage devices of an accumulator block type or a battery storage device for frequency regulation, because the constant charge/discharge cycles lead very quickly, namely within a few weeks and at best months, to irreversible losses in capacity and force the already mentioned exchange of such a storage device. However, intermediate storage devices of an accumulator block type or other battery storage devices could be used to form a “long-term storage device,” which takes over the supply of power during losses on the order of minutes (e.g., from a range of 5-15 minutes), while dynamically loadable Ultracap model intermediate storage devices and/or a flywheel storage device are used for frequency regulation, i.e., for reducing the frequency in the network supplying additional energy and for increasing frequency in the network storing energy.

Consequently, different ways of using the intermediate storage devices of various types for still justifiable costs in the network, especially for an island network, can contribute to frequency stability of the network, but can also reliably bridge losses in power in the generation of electrical energy on the generator side for a few minutes. Consequently, through the different use of intermediate storage devices of different types, the network is protected, on one hand, in terms of frequency stability, on the other, in terms of the sufficient power supply for a time in the range of minutes, when the available energy on the generator side is not sufficient.

Because the individual components of the generator side are controlled by the controller device 42, and the controller device also recognizes what type of network-supporting measures must be performed, through a corresponding control of the intermediate storage devices, various types can be used; first, an intermediate storage device for stabilizing the network power frequency, and second, another intermediate storage device for bridging times without power on the generator side in the range of minutes. Simultaneously, through the different use of intermediate storage devices of various types, for different network problems, the costs for the entire intermediate storage device can still be reduced to a relative minimum.

Therefore, in the reduction to practice, it is advantageous that the intermediate storage device of an accumulator block type or a battery storage device provide a considerably larger energy charging capacity than Ultracap intermediate storage devices or flywheel storage devices. Thus, e.g., the capacity in the intermediate storage device of an accumulator type or a battery storage device can be significantly more than five to ten times as large as the capacity of an intermediate storage device of an Ultracap or a flywheel storage device type.

1. An isolated electrical network with at least one first power generator, which uses a renewable energy source, wherein the power generator is preferably a wind-power station with a generator, wherein a second generator is provided, which can be coupled to an internal combustion engine, wherein the wind-power station can be controlled in terms of its rpm and blade position, characterized in that a bus bar for feeding the generated energy into the network is formed and a device connected to a bus bar for detecting the power required in the network is provided, and at least one intermediate storage device for storing electrical energy is provided, wherein the intermediate storage device can be coupled to the first power generator and for the case that the output power of the first power generator is greater than the power of the load required in the network, at first electrical energy of the first generator is supplied to the intermediate storage device if the intermediate storage device is not full, and/or if more energy is consumed in the network than is generated by the first power generator, at first the electrical intermediate storage device used for delivering power.

2. The isolated electrical network according to claim 1, characterized in that the first power generator has a synchronous generator, which contains a converter with a dc voltage intermediate circuit with at least one first rectifier and an inverter.

3. The isolated electrical network according to claim 1, characterized by at least one electrical element connected to the dc voltage intermediate circuit for feeding electrical energy with dc voltage.

4. The isolated electrical network according to claim 3, characterized in that the electrical element is a photovoltaic element and/or a mechanical energy storage device and/or an electrochemical storage device and/or a capacitor and/or a chemical storage device as the electrical intermediate storage device.

5. The isolated electrical network according to claim 1, characterized by a flywheel, which can be coupled to the second or a third generator.

6. The isolated electrical network according to claim 1, characterized by several internal combustion engines, which can each be coupled to a generator.

7. The isolated electrical network according to claim 1, characterized by a controller for controlling the island network.

8. The isolated electrical network according to claim 1, characterized by a boost/buck converter between the electrical element and the dc voltage intermediate circuit.

9. The isolated electrical network according to claim 1, characterized by charging/discharging circuits between the electrical storage element and the dc voltage intermediate circuit.

10. The isolated electrical network according to claim 1, characterized by a flywheel with a generator and a downstream rectifier for supplying electrical energy into the dc voltage intermediate circuit.

11. The isolated electrical network according to claim 1, characterized in that all of the power generators using renewable energy sources and intermediate storage devices power a common dc voltage intermediate circuit.

12. The isolated electrical network according to claim 1, characterized by a network-commutated inverter.

13. The isolated electrical network according to claim 1, characterized in that the energy for operating the electromagnetic coupling is made available by an electrical storage device and/or by a primary power generator.

14. The isolated network according to claim 1, characterized in that a seawater desalination/service water generation plant is connected to the island network, wherein this plant generates service water (drinking water), when the power supplied by the primary power generator is greater than the power consumption of the other electrical loads connected to the island network.

15. The isolated network according to claim 1, characterized in that a pump storage device is provided, which receives its electrical energy from the primary power generator.

16. An isolated electrical network with at least one first primary power generator for generating electrical energy for an electrical island network, wherein a synchronous generator is provided, which has the function of a network generator, wherein the synchronous generator can operate in motor mode and the energy required for the motor operation is made available by the primary power generator.

17. The isolated network according to claim 16, characterized in that the generator can be connected to an internal combustion engine, which is deactivated when the electrical power of the primary power generator is greater or approximately the same size as the electrical power consumption in the island network.

18. The isolated network according to claim 16 and with a bus bar for feeding the generated energy into the network, characterized by a device attached to the bus bar for detecting the power required in the network.

19. A method for operation control of an isolated electrical island network with at least one wind-power station, characterized in that the wind-power station is controlled such that it always generates only the required electrical power as long as the consumption of the electrical power in the network is less than the electrical energy generation capacity of the wind-power station.

20. The method according to claim 19, characterized in that when the required power is not met, the power generators using renewable energy sources first use electrical intermediate storage devices for delivering energy.

21. The method according to one of claim 19, characterized in that internal combustion engines are provided for driving at least one second generator, and the internal combustion engines are turned on only when the power delivered by the power generators using renewable energy sources and/or by the electrical intermediate storage devices falls below a predetermined threshold for a predetermined period of time.

22. The method according to claim 21, characterized in that for charging the intermediate storage device from renewable sources, more energy is generated than is required for the load on the network.

23. The method according to claim 19, characterized in that for overcoming frequency instabilities or deviations in the network power frequency from its desired value, preferably electrical intermediate storage devices are used for delivering energy, which can be frequently and quickly charged or discharged without significant irreversible losses in capacity.

24. The method according to claim 19, characterized in that intermediate storage devices of an accumulator block type or a battery storage device are used preferably to support the network when the power required by the network can be delivered not at all or only insufficiently from renewable energy-sources.

25. Use of a synchronous generator as a network generator for a network-commutated inverter for feeding an alternating current into an electrical power supply network, wherein the generator works in motor operation and the drive of the generator is realized by a flywheel and/or by providing electrical energy from a renewable-energy power generator.
